(19) United States
(12) Patent Application Publication
(10) Pub. No.: US 2017/0197881 A1
(43) Pub. Date: Jul. 13, 2017

(54) COBALT FREE PREPROMOTED UNSATURATED POLYESTER RESIN SYSTEM FOR ENGINEERED STONE

(71) Applicant: ASHLAND LICENSING AND INTELLECTUAL PROPERTY LLC, Dublin, OH (US)

(72) Inventors: José Luís Miquel Peraire, Barcelona (ES); Javier López De Alda Madorran, Benicarlo Castellon (ES); Tuomo SJÖBERG, Helsinki (FI)

(73) Assignee: ASHLAND LICENSING AND INTELLECTUAL PROPERTY LLC, Dublin, OH (US)

(21) Appl. No.: 15/321,136

(22) PCT Filed: Jun. 29, 2015
(86) PCT No.: PCT/US15/38250

§ 371 Date: Dec. 21, 2016

(30) Foreign Application Priority Data
Jul. 1, 2014 (EP) 14175272.5

(51) Int. Cl. C04B 26/18

(52) U.S. Cl. CPC C04B 26/18; C04B 2111/54

(57) ABSTRACT

The invention relates to a formable composition for the preparation of engineered stone comprising a cobalt free prepromoted unsaturated polyester resin system, an inorganic particulate material and a peroxide component. The invention also relates to a method for the preparation of engineered stone as well as to the use of the cobalt free prepromoted unsaturated polyester resin system for the preparation of engineered stone.

The invention relates to a cobalt free prepromoted unsaturated polyester resin system which is useful for the preparation of engineered stone. When mixing the cobalt free prepromoted unsaturated polyester resin system with an inorganic particulate material such as crushed stone and with a peroxide component, a formable composition is obtained that can be further processed and cured to finally yield engineered stone as composite material. The invention also relates to a method for the preparation of engineered stone as well as to the use of the cobalt free prepromoted unsaturated polyester resin system for the preparation of engineered stone.

In the conventional manufacture of engineered stone slabs a resin formulation is mixed with crushed stone, typically quartz fillers and/or quartz aggregates of defined particle sizes. The resin formulation is curable upon activation by addition of a metal catalyst and peroxide. After addition of said metal catalyst and peroxide, curing of the resin formulation commences and proceeds until the resin has been completely cured. During the interim period (pot life) the curing composition can be formed into the desired shape of the engineered stone.

In the course of established processes for the production of engineered stone, the curing composition is prepared at the site of manufacture. At moderate temperatures of e.g. 40° C., the curing composition should be processable for a sufficient period of time, typically for at least 1.5 hours, whereas at elevated temperatures of e.g. 80° C., the processed curing composition should rapidly cure, typically within 7 to 12 minutes. These are standards in the industry.

Once the curing composition has been prepared, its curing properties are not easy to determine. The gel time is an established indicator for the curing properties. For a given resin, the time lapsed until gelling commences is typically determined by preliminary tests on the resin alone. Based upon long term experience it can then be reliably predicted how long the curing composition may be processed, i.e. for how long the production line may be operated without shutdown.

It is known to increase the processability of curing composition at moderate temperatures by adding inhibitors. However, such inhibitors also have a detrimental influence because they also extend the curing time at elevated temperatures. There is a demand for both, extended processability at moderate temperatures as well as short gelling times at increase temperatures.

U.S. Pat. No. 8,026,298 relates to a method for the preparation of engineered stone slab having coated lumps of composite stone material. U.S. Pat. No. 8,436,074 relates to artificial marble, and system and method of producing artificial marble.

U.S. Pat. No. 4,032,596 pertains to curing of unsaturated polyester resins in admixture with ethylenically unsaturated copolymerizable monomers and is particularly concerned with promoting or accelerating the cross linking of such polyester with such vinyl monomers during curing while retaining serviceable shelf-life during storage of the permix at ambient or room temperatures.

WO 2012/104020 relates to a gelcoat composition comprising a reactive polyester resin and a particulate inorganic filler and to a method of applying the gelcoat composition to suitable substrates such as sanitary basins, e.g. sinks, washbasins, spas, shower basins, lavatories, and the like. The solidified gelcoat provides excellent scratch resistance to the surface of the substrate.

GB-A 834 286 discloses that the storage life of a copolymerizable mixture of an unsaturated alkyd resin and an ethylenic monomer copolymerizable therewith, which mixture contains an inhibitor against premature gelation, can be improved by adding thereto, a copper compound soluble in the alkyd resin mixture in an amount ranging from 0.25 to 10 parts per million, based on the weight of the resinous mixture.

U.S. Pat. No. 3,028,360 is concerned with improving the storage life of polyester resins.

EP-A 2 610 227 discloses an artificial marble including unsaturated polyester resin (A), compound containing silica (B), and luminescent pigment (C).

Conventional resin formulations rely on cobalt catalysts that have several disadvantages. Cobalt and its ions have been classified as being hazardous to health and environment. Further, cobalt salts are often colored having a negative impact on the appearance of the engineered stone. Furthermore, the pot life of the conventional systems is comparatively short, especially in countries with comparatively high ambient temperatures, thus requiring frequent shut down of production lines for cleaning purposes.

There is a demand for methods for the preparation of engineered stone that overcome the drawbacks of the prior art. The engineered stone should have natural color and should not be hazardous to health and environment. During its manufacture, pot life should be sufficient thus avoiding frequent shut down of production lines.

This object has been achieved by the subject-matter of the patent claims.

It has been surprisingly found that engineered stone can be prepared from cobalt free resins providing long pot life.

A first aspect of the invention relates to a formable composition for the preparation of engineered stone comprising
(A) a cobalt free prepromoted unsaturated polyester resin system comprising
   (i) a unsaturated polyester resin component; preferably a reaction product of a mixture comprising at least 1, 2 or 3 diols selected from the group consisting of propylene glycol, dipropylene glycol, ethylene glycol, and diethylene glycol; and at least 1, 2, 3 or 4 acids selected from the group consisting of maleic acid, isopthalic acid, phthalic acid, and adipic acid, or their acid anhydrides;
   (ii) a metal catalyst capable of catalyzing curing of said unsaturated polyester resin component; preferably a zinc salt of a carboxylic acid, more preferably a zinc salt of a C₁₋₂₀ carboxylic acid, still more preferably a zinc salt of a C₆₋₁₂ carboxylic acid, most preferably zinc octanoate;
   (iii) a quaternary ammonium salt; preferably a benzyl-N,N,N-trialkylammonium salt or a N,N,N,N-tetraalkylammonium salt; and
   (iv) optionally, one or more additives selected from the group consisting of reactive diluents, accelerators, co-promoters, dispersing agents, UV absorbers, stabilizers, inhibitors and rheology modifiers;
(B) an inorganic particulate material; and
(C) a peroxide component; preferably cumene hydroperoxide and/or methyl isobutyl ketone peroxide.

The formable composition according to the invention has the advantage that it can be processed on conventional plants for the manufacture of engineered stone without any adaptations. Furthermore, as the unsaturated polyester resin system contained in the formable composition is prepromoted already, the final manufacturing process merely requires the mixing of (A), (B) and (C) with one another and thus, facilitates the process compared to conventional processes requiring separate addition of metal catalyst (promoter).

Preferably, the content of the cobalt free prepromoted unsaturated polyester resin system (total content of (i), (ii), (iii) and (iv)) is about 0.1 wt.-% to about 30 wt.-%, more preferably about 5 wt.-% to about 20 wt.-%, relative to the total weight of the formable composition. Preferably, the content of the cobalt free prepromoted unsaturated polyester resin system (total content of (i), (ii), (iii) and (iv)) is within the range of about 10±7 wt.-%, more preferably about 10±6 wt.-%, still more preferably about 10±5 wt.-%, yet more preferably about 10±4 wt.-%, even more preferably about 10±3 wt.-%, most preferably about 10±2 wt.-%, and in particular about 10±1 wt.-%, relative to the total weight of the formable composition.

The cobalt free prepromoted unsaturated polyester resin system according to the invention is cobalt free. For the purpose of the invention, “cobalt free” means that the system contains substantially no cobalt, preferably at most 10 ppm, more preferably at most 5 ppm, most preferably at most 1 ppm cobalt, and in particular no detectable cobalt at all. Suitable methods for determining the cobalt content of a system are known to the skilled person such as ESCA or high resolution inductively coupled plasma mass spectrometry.

In a preferred embodiment, not only the cobalt free prepromoted unsaturated polyester resin system, but the entire formable composition according to the invention is cobalt free, i.e. the inorganic particulate material as well as the peroxide component are cobalt free as well, such that no cobalt is entrained.

For the purpose of the invention, a “prepromoted” resin already contains the metal catalyst as promoter, but not yet the initiator (peroxide) for the radical reaction that causes curing. The prepromoted resin has long shelf-life and may be marketed as precursor. The initiator (peroxide) is then shortly added before the prepromoted resin is employed in the production of the final product, i.e. of the engineered stone.

It has been surprisingly found that when employing zinc salts or copper salts instead of cobalt salts as metal catalysts (promoters), the cobalt free unsaturated polyester resin system has a long shelf life. Thus, the marketed cobalt free unsaturated polyester resin system may already initially contain the zinc salts or copper salts, thus rendering the unsaturated polyester resin system a “prepromoted” unsaturated polyester resin system. Thus, when preparing engineered stone from the cobalt free prepromoted unsaturated polyester resin system according to the invention, only the initiator (peroxide) needs to be added, but not the metal catalyst (promoter), which is already contained. This makes the cobalt free unsaturated polyester resin system safer and easier to handle compared to conventional systems that require separate addition of initiator and cobalt promoter.

Unsaturated polyester resin components are known to a skilled person and for the purposes of the invention not particularly limited. Typically, the unsaturated polyester resin components according to the invention are characterized by a polymerizable C═C double bond, optionally in conjugation with a carbonyl bond.

These unsaturated polyester resin components are obtained by the condensation of carboxylic acid monomers with polyhydric alcohol monomers. The polyester may then be dissolved in a reactive monomer, such as styrene, to obtain a solution that may then be crosslinked. One skilled in the art will appreciate that there are many different processes and methods for making unsaturated polyester resin components and other resins having ethylenic unsaturation that may be applied within the scope of the invention.

Preferably, the unsaturated polyester resin component that is contained in the cobalt free prepromoted unsaturated polyester resin system according to the invention is obtained by reacting a mixture comprising a multicarboxylic acid component (free acid, salt, anhydride) and a polyhydric alcohol component, wherein the multicarboxylic acid component and/or the polyhydric alcohol component comprises ethylenic unsaturation. Said mixture may also comprise saturated or unsaturated, aliphatic or aromatic monocarboxylic acids and/or saturated or unsaturated, aliphatic or aromatic monoalcohols in order to adjust the average molecular weight of the polyester molecules.

Preferably, the unsaturated polyester resin component is obtained by reacting a mixture comprising a polyol and a carboxylic acid, a carboxylic acid ester and/or a carboxylic acid anhydride, i.e. the unsaturated polyester resin component is derived from a monomer composition (in the following also referred to as “mixture”) comprising a polyol and a carboxylic acid, a carboxylic acid ester and/or a carboxylic acid anhydride.

In a preferred embodiment, the mixture comprises a polyol and a polycarboxylic acid, a polycarboxylic acid ester and/or a polycarboxylic acid anhydride, i.e. the unsaturated polyester resin component is the condensation product of one or more polycarboxylic acids, polycarboxylic acid esters and/or polycarboxylic acid anhydrides with one or more polyols. More preferably, the mixture comprises a polyol and a polycarboxylic acid and/or a polycarboxylic acid anhydride, i.e. the unsaturated polyester resin component is the condensation product of one or more polycarboxylic acids and/or polycarboxylic acid anhydrides with one or more polyols.

In another preferred embodiment, the mixture comprises a carboxylic acid, a carboxylic acid ester and/or a carboxylic acid anhydride, wherein the carboxylic acid, the carboxylic acid ester and/or the carboxylic acid anhydride are/is selected from aliphatic and aromatic polycarboxylic acids and/or the esters and anhydrides thereof, wherein the term “aliphatic” covers acyclic and cyclic, saturated and unsaturated polycarboxylic acids and the esters and anhydrides thereof. Preferably, the carboxylic acid, the carboxylic acid ester and/or the carboxylic acid anhydride are/is selected from unsaturated and aromatic polycarboxylic acids and/or the esters and anhydrides thereof. More preferably, the carboxylic acid, the carboxylic acid ester and/or the carboxylic acid anhydride are/is selected from unsaturated polycarboxylic acids and/or the esters and anhydrides thereof.

In another preferred embodiment, the mixture comprises a carboxylic acid, a carboxylic acid ester and/or a carboxylic acid anhydride, wherein the carboxylic acid, the carboxylic acid ester and/or the carboxylic acid anhydride are/is selected from unsaturated polycarboxylic acids and/or the esters and anhydrides thereof, and used in combination with a second carboxylic acid, carboxylic acid ester and/or carboxylic acid anhydride, which are/is selected from aliphatic and/or aromatic polycarboxylic acids and/or the esters and anhydrides thereof. Preferably, the carboxylic acid, the carboxylic acid ester and/or the carboxylic acid anhydride are/is selected from unsaturated polycarboxylic acids and/or the esters and anhydrides thereof, and used in combination with a second carboxylic acid, carboxylic acid ester and/or carboxylic acid anhydride, which are/is selected from saturated and/or aromatic polycarboxylic acids and/or the esters and anhydrides thereof. More preferably, the carboxylic acid, the carboxylic acid ester and/or the carboxylic acid anhydride are/is selected from unsaturated polycarboxylic acids and/or the esters and anhydrides thereof, and used in combination with a second carboxylic acid, carboxylic acid ester and/or carboxylic acid anhydride, which are/is selected from aromatic polycarboxylic acids and/or the esters and anhydrides thereof. Even more preferably, the carboxylic acid, the carboxylic acid ester and/or the carboxylic acid anhydride are/is selected from unsaturated polycarboxylic acids and/or the esters and anhydrides thereof, and used in combination with a second carboxylic acid, carboxylic acid ester and/or carboxylic acid anhydride, which are/is selected from aromatic polycarboxylic acids and/or the esters and anhydrides thereof, wherein the second carboxylic acid, carboxylic acid ester and/or carboxylic acid anhydride have/has a limited weight proportion in the reactive unsaturated polyester resin system compared to the carboxylic acid, the carboxylic acid ester and/or the carboxylic acid anhydride selected from unsaturated polycarboxylic acids and/or the esters and anhydrides thereof, the weight ratios (second carboxylic acid, carboxylic acid ester and/or carboxylic acid anhydride:carboxylic acid, the carboxylic acid ester and/or the carboxylic acid anhydride selected from unsaturated polycarboxylic acids and/or the esters and anhydrides thereof) being less than about 0.8:1, preferably less than about 0.5:1, more preferably about less than 0.2:1, even more preferably less than about 0.1:1, and most preferably less than about 0.05:1.

The use of the saturated and/or aromatic polycarboxylic acids, polycarboxylic acid esters and/or polycarboxylic acid anhydrides in combination with unsaturated polycarboxylic acids, polycarboxylic acid esters and/or polycarboxylic acid anhydrides may serve to decrease the crosslink density after curing of the unsaturated polyester resin component, and consequently the unsaturated polyester resin component will typically be more flexible, shock resistant, unbrittle, and the like.

In another preferred embodiment, the mixture comprises a carboxylic acid, a carboxylic acid ester and/or a carboxylic acid anhydride, wherein the carboxylic acid, the carboxylic acid ester and/or the carboxylic acid anhydride are/is exclusively selected from unsaturated polycarboxylic acids and/or the esters and anhydrides thereof, and a combined use with another carboxylic acid, carboxylic acid ester and/or carboxylic acid anhydride is excluded. Preferably, the mixture exclusively comprises an unsaturated polycarboxylic acid, an unsaturated polycarboxylic acid ester or an unsaturated polycarboxylic acid anhydride. More preferably, the mixture exclusively comprises an unsaturated polycarboxylic acid or an unsaturated polycarboxylic acid anhydride. Most preferably, the mixture exclusively comprises an unsaturated polycarboxylic acid anhydride.

The exclusive use of unsaturated polycarboxylic acids, polycarboxylic acid esters and/or polycarboxylic acid anhydrides typically results in a high crosslink density after curing, and consequently in a high resin stability.

Preferably, the multicarboxylic acid component is selected from the group consisting of aliphatic dicarboxylic acids, aliphatic tricarboxylic acids, aliphatic tetracarboxylic acids, aromatic dicarboxylaic acids, aromatic tricarboxylic acids, aromatic tetracarboxylic acids, and their corresponding acid anhydrides. A skilled person recognizes that the multicarboxylic acids bay also be employed in form of esters, e.g. methyl esters or ethyl esters, in the corresponding transesterification reactions.

Exemplary unsaturated polycarboxylic acids include chloromaleic acid, citraconic acid, fumaric acid, itaconic acid, maleic acid, mesaconic acid, and methyleneglutaric acid. Preferred unsaturated polycarboxylic acids are fumaric acid, itaconic acid, maleic acid and mesaconic acid, glutaconic acid, traumatic acid, muconic acid, nadic acid, methylnadic acid, tetrahydrophthalic acid, hexahydrophthalic acid. More preferred unsaturated polycarboxylic acids are fumaric acid and maleic acid. The most preferred unsaturated polycarboxylic acid is maleic acid.

Exemplary unsaturated polycarboxylic acid esters can be derived from chloromaleic acid, citraconic acid, fumaric acid, itaconic acid, maleic acid, mesaconic acid, and methyleneglutaric acid. Preferred unsaturated polycarboxylic acids are fumaric acid, itaconic acid, maleic acid and mesaconic acid.

Exemplary unsaturated polycarboxylic acid anhydrides can be derived from chloromaleic acid, citraconic acid, fumaric acid, itaconic acid, maleic acid, mesaconic acid, and methyleneglutaric acid. Preferred unsaturated polycarboxylic acid anhydrides are the unsaturated polycarboxylic acid anhydrides of chloromaleic acid, maleic acid, citraconic acid, and itaconic acid. More preferred unsaturated polycarboxylic acid anhydrides are maleic anhydride, citraconic anhydride, and itaconic anhydride. The most preferred unsaturated polycarboxylic acid anhydride is maleic anhydride.

Exemplary saturated polycarboxylic acids include adipic acid, chlorendic acid, dihydrophthalic acid, dimethyl-2,6-naphthenic dicarboxylic acid, d-methyl glutaric acid, dodecanedicarboxylic acid, glutaric acid, hexahydrophthalic acid, oxalic acid, malonic acid, suberic acid, azelaic acid, nadic acid, pimelic acid, sebacic acid, succinic acid, tetrahydrophthalic acid, 1,2-cyclohexane dicarboxylic acid, 1,3-cyclohexane dicarboxylic acid, 1,4-cyclohexane dicarboxylic acid, and Diels-Alder adducts made from maleic anhydride and cyclopentadiene. Preferred saturated polycarboxylic acids are succinic acid, glutaric acid, d-methyl glutaric acid, adipic acid, sebacic acid, and pimelic acid. More preferred saturated polycarboxylic acids are adipic acid, succinic acid, and glutaric acid.

Exemplary saturated polycarboxylic acid esters can be derived from adipic acid, chlorendic acid, dihydrophthalic acid, dimethyl-2,6-naphthenic dicarboxylic acid, d-methyl glutaric acid, dodecanedicarboxylic acid, glutaric acid, hexahydrophthalic acid, nadic acid, pimelic acid, sebacic acid, succinic acid, tetrahydrophthalic acid, 1,2-cyclohexane dicarboxylic acid, 1,3-cyclohexane dicarboxylic acid, 1,4-cyclohexane dicarboxylic acid, and Diels-Alder adducts made from maleic anhydride and cyclopentadiene.

Exemplary saturated polycarboxylic acid anhydrides can be derived from adipic acid, chlorendic acid, dihydrophthalic acid, dimethyl-2,6-naphthenic dicarboxylic acid, dimethylglutaric acid, dodecanedicarboxylic acid, glutaric acid, hexahydrophthalic acid, nadic acid, pimelic acid, sebacic acid, succinic acid, tetrahydrophthalic acid, 1,2-cyclohexane dicarboxylic acid, 1,3-cyclohexane dicarboxylic acid, 1,4-cyclohexane dicarboxylic acid, and Diels-Alder adducts made from maleic anhydride and cyclopentadiene. Preferred saturated polycarboxylic acid anhydrides are the saturated polycarboxylic acid anhydrides of chlorendic acid, dihydrophthalic acid, dimethylglutaric acid, glutaric acid, hexahydrophthalic acid, nadic acid, succinic acid, tetrahydrophthalic acid. More preferred saturated polycarboxylic acid anhydrides are dihydrophthalic anhydride, hexahydrophthalic anhydride, tetrahydrophthalic anhydride, and succinic anhydride.

Exemplary aromatic polycarboxylic acids include isophthalic acid, phthalic acid, terephthalic acid, tetrachlorophthalic acid, trimellitic acid, 1,2,4,5-benzenetetracarboxylic acid, and 1,2,4-benzenetricarboxylic acid. Preferred aromatic polycarboxylic acids are isophthalic acid, phthalic acid, terephthalic acid, and tetrachlorophthalic acid. More preferred aromatic polycarboxylic acids are isophthalic acid, and phthalic acid. The most preferred aromatic polycarboxylic acid is isophthalic acid.

Exemplary aromatic polycarboxylic acid esters can be derived from isophthalic acid, phthalic acid, terephthalic acid, tetrachlorophthalic acid, trimellitic acid, 1,2,4,5-benzenetetracarboxylic acid, and 1,2,4-benzenetricarboxylic acid.

Exemplary aromatic polycarboxylic acid anhydrides can be derived from isophthalic acid, phthalic acid, terephthalic acid, tetrachlorophthalic acid, trimellitic acid, 1,2,4,5-benzenetetracarboxylic acid, and 1,2,4-benzenetricarboxylic acid. Preferred aromatic polycarboxylic acid anhydrides are the aromatic polycarboxylic acid anhydrides of phthalic acid and tetrachlorophthalic acid. The most preferred aromatic polycarboxylic acid anhydride is phthalic anhydride.

In another preferred embodiment, the mixture comprises a blend of a carboxylic acid, a carboxylic acid ester and/or a carboxylic acid anhydride, wherein the carboxylic acid, the carboxylic acid ester and/or the carboxylic acid anhydride are/is selected from aliphatic and aromatic dicarboxylic acids and/or the esters and anhydrides thereof, wherein the term “aliphatic” covers acyclic and cyclic, saturated and unsaturated dicarboxylic acids and the esters and anhydrides thereof. Preferably, a first carboxylic acid, the carboxylic acid ester and/or carboxylic acid anhydride are/is selected from unsaturated dicarboxylic acids and/or esters and anhydrides thereof, and is used in combination with a second carboxylic acid, carboxylic acid ester and/or carboxylic acid anhydride, which are/is selected from saturated and/or aromatic polycarboxylic acids and/or the esters and anhydrides thereof. More preferably, a first carboxylic acid and/or a carboxylic acid anhydride selected from fumaric acid, maleic acid, and maleic anhydride is used in combination with a second carboxylic acid and/or carboxylic acid anhydride selected from isophthalic acid, phthalic acid, terephthalic acid, and phthalic anhydride. More preferably, maleic anhydride is used in combination with isophthalic acid.

In another preferred embodiment, the mixture further comprises a monocarboxylic acid. Preferably, the reactive polyester resin system comprises the monocarboxylic acid in amounts from about 0.01 wt.-% to about 10 wt.-%, more preferably from about 0.01 wt.-% to about 2 wt.-%, relative to the unsaturated polyester resin system. Exemplary monocarboxylic acids include acrylic acid, benzoic acid, ethylhexanoic acid, and methacrylic acid. Preferred monofunctional carboxylic acids are acrylic acid and methacrylic acid.

Preferably, the polyhydric alcohol is selected from the group consisting of aliphatic diols, aliphatic triols, aliphatic tetraols, aromatic diols, aromatic triols and aromatic tetraols.

Examples of aliphatic polyhydric alcohols include but are not limited to ethylene glycol, propylene glycol, 1,3-propanediol, 1,4-propanediol, 1,4-butanediol, 2,2-dimethyl-1,3-propanediol, 2-methyl-1,3-propanediol, glycerol, trimethylol propane and oxyalkylated adducts thereof such as glycol ethers, e.g. diethylene glycol, dipropylene glycol, and polyoxyalkylene glycol.

Examples of aromatic polyhydric alcohols include but are not limited to bisphenol A, bisphenol AF, bisphenol AP, bisphenol B, bisphenol BP, bisphenol C, bisphenol E, bisphenol F, bisphenol FL, bisphenol G, bisphenol M, bisphenol P, bisphenol PH, bisphenol S, bisphenol TMC, and bisphenol Z.

In a preferred embodiment, the polyol is selected from aliphatic and aromatic polyols, wherein the term “aliphatic” covers acyclic and cyclic, saturated and unsaturated polyols. Preferably, the polyol is selected from aliphatic polyols. More preferably, the polyols are selected from aliphatic polyols having from 2 to 12 carbon atoms. Still more preferably, the polyols are selected from diols having from 2 to 10 carbon atoms, most preferably from diols having 3, 4, 6, 7, 8, 9 or 10 carbon atoms. It is particularly preferred that the polyol is a diol having 3 carbon atoms.

Exemplary diols include alkanediols, butane-1,4-diol, 2-butyl-2-ethyl-1,3-propanediol (BEPD), 1,3-butylene glycol, butane-1,4-diol, cyclohexane-1,2-diol, cyclohexane dimethanol, diethyleneglycol, 2,2-dimethyl-1,4-butanediol, 2,2-dimethylheptanediol, 2,2-dimethyloctanediol, 2,2-dimethylpropane-1,3-diol, dipentaerythritol, dipropylene glycol, di-trimethylolpropane, ethyleneglycol, hexane-1,6-diol, 2-methyl-1,3-propanediol, neopentyl glycol, 5-norbornene-2,2-dimethylol, 2,3-norbornene diol, oxa-alkanediols, pentaerythritol, poly-ethylenepropane-3-diol, 1,2-propanediol, 1,2-propyleneglycol, triethyleneglycol, trimethylolpropane, tripentaerythirol, 2,2,4-trimethyl-1,3-pentanediol, and 2,2-bis(p-hydroxycyclohexyl)-propane.

In a preferred embodiment, the polyol is a diol selected from the group consisting of butane-1,4-diol, 2-butyl-2-ethyl-1,3-propanediol (BEPD), 1,3-butylene glycol, cyclohexane-1,2-diol, cyclohexane dimethanol, diethylenglycol, 2,2-dimethyl-1,4-butanediol, 2,2-dimethylheptanediol, 2,2-dimethyloctanediol, 2,2-dimethylpropane-1,3-diol, dipentaerythritol, dipropylene glycol, di-trimethylolpropane, hexane-1,6-diol, 2-methyl-1,3-propanediol, 5-norbornene-2,2-dimethylol, 2,3-norbornene diol, oxa-alkanediols, pentaerythritol, polyethylene glycol, propane-3-diol, 1,2-propanediol (also called 1,2-propyleneglycol), triethyleneglycol, trimethylolpropane, tripentaerythritol, 2,2,4-trimethyl-1,3-pentanediol, and 2,2-bis(p-hydroxycyclohexyl)-propane. More preferably, the polyol is selected from the group consisting of 1,2-propanediol (1,2-propylene glycol), dipropylene glycol, and cyclohexane-1,2-diol. Still more preferably, the polyol is selected from 1,2-propanediol (1,2-propylene glycol) and dipropylene glycol. It is particularly preferred that the polyol is 1,2-propanediol (1,2-propylene glycol), dipropylene glycol or a combination thereof. Most preferably, the polyol is 1,2-propanediol (1,2-propylene glycol).

In another preferred embodiment, the mixture further comprises a monofunctional alcohol. Preferably, the mixture comprises the monofunctional alcohol in amounts from about 0.01 wt.-% to about 10 wt.-%, more preferably from about 0.01 wt.-% to about 2 wt.-%, relative to the unsaturated polyester resin component. Exemplary monofunctional alcohols include benzyl alcohol, cyclohexanol, 2-ethyhexyl alcohol, 2-cyclohexyl ethanol, and lauryl alcohol.

In a preferred embodiment, the mixture comprises a diol selected from the group consisting of butane-1,4-diol, 2-butyl-2-ethyl-1,3-propanediol (BEPD), 1,3-butylene glycol, cyclohexane-1,2-diol, cyclohexane dimethanol, diethylenglycol, 2,2-dimethyl-1,4-butanediol, 2,2-dimethylheptanediol, 2,2-dimethyloctanediol, 2,2-dimethylpropane-1,3-diol, dipentaerythritol, dipropylene glycol, di-trimethylolpropane, hexane-1,6-diol, 2-methyl-1,3-propanediol, 5-norbornene-2,2-dimethylol, 2,3-norbornene diol, oxa-alkanediols, pentaerythritol, polyethylene glycol, propane-3-diol, 1,2-propanediol (also called 1,2-propyleneglycol), triethyleneglycol, trimethylolpropane, tripentaerythritol, 2,2,4-trimethyl-1,3-pentanediol, and 2,2-bis(p-hydroxycyclohexyl)-propane, and a carboxylic acid, a carboxylic acid ester and/or a carboxylic acid anhydride. More preferably, the mixture comprises 1,2-propanediol (also called 1,2-propyleneglycol), dipropylene glycol or a combination thereof as a diol, and a carboxylic acid, a carboxylic acid ester and/or a carboxylic acid anhydride. Most preferably, the mixture comprises 1,2-propanediol (1,2-propylene glycol), and a carboxylic acid, a carboxylic acid ester and/or a carboxylic acid anhydride.

In another preferred embodiment, the unsaturated polyester resin component is a condensation product of one of the above mentioned exemplary polycarboxylic acids, esters and/or anhydrides thereof with one of the above mentioned exemplary diols. Preferably, the unsaturated polyester resin component is a condensation product of maleic anhydride and 1,2-propylene glycol. More preferably, the unsaturated polyester resin component is a condensation product of maleic anhydride and 1,2-propylene glycol in a weight ratio of about (1±0.9):1, preferably about (1±0.5):1, more preferably about (1±0.3):1, even more preferably about (1±0.1):1, and most preferably about 1:1. For example, a unsaturated polyester resin component based on maleic anhydride and 1,2-propylene glycol is available from Ashland Inc. (Dublin, Ohio, U.S.A) under the trade name AROPOL® D 1691.

In another preferred embodiment, the unsaturated polyester resin component is a condensation product of one or more of the above mentioned exemplary polycarboxylic acids, esters and/or anhydrides thereof with one or more of the above mentioned exemplary diols. Preferably, the unsaturated polyester resin component is a condensation product of one or more of the above mentioned exemplary polycarboxylic acids, esters and/or anhydrides thereof with one or more of the above mentioned exemplary diols. More preferably, the unsaturated polyester resin component is a condensation product of a blend of one of the above mentioned exemplary polycarboxylic acids and one of the above mentioned exemplary polycarboxylic acid anhydrides with a blend of two of the above mentioned exemplary diols. Still more preferably, the unsaturated polyester resin component is a condensation product of a blend of one of the above mentioned exemplary aromatic polycarboxylic acids and one of the above mentioned exemplary unsaturated polycarboxylic acid anhydrides with a blend of two of the above mentioned exemplary diols. Yet more preferably, the unsaturated polyester resin component is a condensation product of a blend of isophthalic acid and maleic anhydride with a blend of 1,2-propane diol and dipropylene glycol. For example, a unsaturated polyester resin component based on a blend of isophthalic acid and maleic anhydride and a blend of 1,2-propane diol and dipropylene glycol is available from Ashland Inc. (Dublin, Ohio, U.S.A) under the trade name AROPOL® K 530.

In a particularly preferred embodiment, the unsaturated polyester resin component is a reaction product of a mixture comprising at least 1, 2 or 3 diols selected from the group consisting of propylene glycol, dipropylene glycol, ethylene glycol, and diethylene glycol; and at least 1, 2, 3 or 4 acids selected from the group consisting of maleic acid, isophthalic acid, phthalic acid, and adipic acid, or their acid anhydrides.

In another preferred embodiment, a combination of two unsaturated polyester resin components is employed.

In another preferred embodiment, the unsaturated polyester resin component is a modified unsaturated polyester resin system. Exemplary, the unsaturated polyester resin component system may be formed by reacting an oligoester having a weight average molecular weight of about 200 to about 4,000 with a diisocyanate and a hydroxyalkyl(meth)acrylate to provide a urethane acrylate having terminal vinyl groups.

In a preferred embodiment, the unsaturated polyester resin component is a reactive vinyl ester resin component. Preferably, the vinyl ester resin component is obtained by reacting a mixture comprising a polyol, which is an epoxy resin, and a carboxylic acid, a carboxylic acid ester and/or carboxylic acid anhydride, which are/is an ethylenically unsaturated monocarboxylic acid, an ester and/or an anhydride thereof. Exemplary epoxy resins include bisphenol A diglycidal ether. Exemplary monocarboxylic acids include acrylic acid and methacrylic acids. Examples of acceptable vinyl ester resins include the DERAKANE® vinyl ester resin products available through Ashland Inc. (Dublin, Ohio, U.S.A). Other types of vinyl esters resin components include those based on cycloaliphatic and/or linear aliphatic diepoxides. Examples of cycloaliphatic vinyl esters include those prepared using hydrogenated bisphenol A and cyclohexane. Examples of linear aliphatic vinyl esters include those prepared from neopentyl, propylene, dipropylene, polypropylene, polyethylene, and diethylene glycol diepoxides.

The cobalt free prepromoted unsaturated polyester resin system according to the invention is cobalt free. Thus, cobalt salts such as cobalt naphthenate or cobalt octoate, which are contained in conventional cobalt free prepromoted unsaturated polyester resin system s for the preparation of engineered stone, are not contained in the cobalt free prepromoted unsaturated polyester resin system according to the invention.

The same applies to additives that are contained in conventional cobalt free prepromoted unsaturated polyester resin system for the preparation of engineered stone in order to support the effect of the cobalt catalysts, such as dimethylaniline (DMA) or diethylaniline (DEA). Preferably, the cobalt free prepromoted unsaturated polyester resin system according to the invention contains neither DMA nor DEA.

Preferably, the metal catalyst that is contained in the cobalt free prepromoted unsaturated polyester resin system according to the invention comprises zinc or copper, preferably in form of a zinc salt or a copper salt.

In a preferred embodiment, the metal catalyst is a zinc salt. The zinc salts of carboxylic acids are preferred. Non-limiting examples of typical zinc salts include the zinc salts of C₁₋₂₀ carboxylic acids and polycarboxylic acids, preferably zinc salts of C₆₋₁₂ carboxylic acid and polycarboxylic acids, including zinc acetate, zinc propionate, zinc butyrate, zinc pentanoate, zinc hexanoate, zinc heptanoate, zinc 2-ethyl hexanoate, zinc octanoate, zinc nonanoate, zinc decanoate, zinc neodecanoate, zinc undecanoate, zinc undecenylate, zinc dodecanoate, zinc palmitate, zinc stearate, zinc oxalate, and zinc naphthenate. Other zinc salts useful herein include the zinc salts of amino acids such as zinc alanine, zinc methionine, zinc glycine, zinc asparagine, zinc aspartine, zinc serine, and the like. Other zinc salts include zinc citrate, zinc maleate, zinc benzoate, zinc acetylacetonate, and the like. Other zinc salts include zinc chloride, zinc sulfate, zinc phosphate, and zinc bromide. The zinc chalcogens and zinc oxide can also be used. Zinc octoanate (zinc octoate) is particularly preferred.

In another preferred embodiment, the metal catalyst is a copper salt. Preferred copper salts are copper (I) salts or copper (II) salts. Preferred copper salts include but are not limited to copper acetate, copper octanoate, copper naphthenate, copper acetylacetonate, copper chloride or copper oxide.

The content of the metal catalyst, preferably zinc octanoate, relative to the total weight of the cobalt free prepromoted unsaturated polyester resin system according to the invention, is preferably within the range of from about 0.001 wt.-% to about 1 wt.-%, more preferably about 0.01 wt.-% to about 0.1 wt.-%. Preferably, the content of the metal catalyst, preferably zinc octanoate, relative to the total weight of the cobalt free prepromoted unsaturated polyester resin system according to the invention, is within the range of about 0.20±0.15 wt.-%, more preferably about 0.20±0.10 wt.-%, most preferably about 0.20±0.05 wt.-%.

The content of the metal catalyst, preferably zinc octanoate, relative to the total weight of the formable composition according to the invention, is preferably within the range of from about 0.0001 wt.-% to about 0.1 wt.-%, more preferably about 0.001 wt.-% to about 0.01 wt.-%. Preferably, the content of the metal catalyst, preferably zinc octanoate, relative to the total weight of the formable composition according to the invention, is within the range of about 0.020±0.015 wt.-%, more preferably about 0.020±0.010 wt.-%, most preferably about 0.020±0.005 wt.-%.

Preferably, the quaternary ammonium salt that is contained in the cobalt free prepromoted unsaturated polyester resin system according to the invention is a benzyl-N,N,N-trialkylammonium salt or a N,N,N,N-tetraalkylammonium salt. Preferred representatives include but are not limited to benzyl-N,N,N-trimethylammonium salts such as benzyl-N,N,N-trimethylammonium chloride; and benzalkonium chlorides such as benzyl-N,N,N—C₂₋₂₀-alkyl-dimethyl-ammonium salts, e.g. benzyl-N,N,N—C₂₋₂₀-alkyl-dimethyl-ammonium chloride, N,N—C₂₋₂₀-dialkyl-N,N-dimethyl ammonium salts, and the mixtures thereof.

The content of the quaternary ammonium salt, relative to the total weight of the cobalt free prepromoted unsaturated polyester resin system according to the invention, is preferably within the range of from about 0.001 wt.-% to about 5 wt.-%, more preferably about 0.01 wt.-% to about 0.5 wt.-%. Preferably, the content of the quaternary ammonium salt, relative to the total weight of the cobalt free prepromoted unsaturated polyester resin system according to the invention, is within the range of about 0.20±0.15 wt.-%, more preferably about 0.20±0.10 wt.-%, most preferably about 0.20±0.05 wt.-%.

The content of the quaternary ammonium salt, relative to the total weight of the formable composition according to the invention, is preferably within the range of from about 0.0001 wt.-% to about 0.5 wt.-%, more preferably about 0.001 wt.-% to about 0.05 wt.-%. Preferably, the content of the quaternary ammonium salt, relative to the total weight of the formable composition according to the invention, is within the range of about 0.020±0.015 wt.-%, more preferably about 0.020±0.010 wt.-%, most preferably about 0.020±0.005 wt.-%.

The cobalt free prepromoted unsaturated polyester resin system according to the invention may comprise one or more additives selected from the group consisting of reactive diluents, accelerators, co-promoters, dispersing agents, UV absorbers, stabilizers, inhibitors and rheology modifiers. Suitable additives are known to the skilled person. In this regard it can be referred to e.g. Ernest W. Flick, Plastics Additives, An Industrial Guide, 3rd ed. 2002, William Andrew Publishing.

The total content of optional additives, relative to the total weight of the cobalt free prepromoted unsaturated polyester resin system according to the invention, is preferably within the range of from about 0.001 wt.-% to about 10 wt.-%, more preferably about 0.01 wt.-% to about 5 wt.-%.

The total content of optional additives, relative to the total weight of the formable composition according to the invention, is preferably within the range of from about 0.0001 wt.-% to about 1 wt.-%, more preferably about 0.001 wt.-% to about 0.5 wt.-%.

Preferably, the cobalt free prepromoted unsaturated polyester resin system comprises a reactive diluent selected from the group consisting of styrene, substituted styrene, nono-, di- and polyfunctional esters of monofunctional acids with alcohols or polyols, mono-, di- and polyfunctional esters of unsaturated monofunctional alcohols with carboxylic acids or their derivatives.

Inhibitors may be contained in the cobalt free prepromoted unsaturated polyester resin system to lengthen the gel time (pot life). Inhibitors are useful when very long gel times are required or when resin is curing quickly due to high temperatures. Some common inhibitors include tertiary butyl catechol, hydroquinone, and toluhydroquinone.

Fillers may be contained in the cobalt free prepromoted unsaturated polyester resin system. Alumina trihydrate may be contained e.g. to improve flame retardancy and reduce smoke emissions. Calcium carbonate, talc and kaolin clays may be contained e.g. to increase the stiffness. Silicon carbide and/or aluminum oxide may be contained in the cobalt free prepromoted unsaturated polyester resin system e.g. to reduce liner deterioration caused by abrasion.

The cobalt free prepromoted unsaturated polyester resin system may further comprise dispersing agents, which are chemicals that aid in the dispersion of solid components in the resin composition, i.e. enhance the dispersion of solid components in the unsaturated resin. Useful dispersing agents include but are not limited to copolymers comprising acidic functional groups like BYK®—W 996 available for Byk USA, Inc., Wallingford, Conn., U.S.A. (“Byk”), unsaturated polycarboxylic acid polymer comprising polysiloxane copolymer, like BYK®—W 995 available from Byk, copolymer comprising acidic functional groups, like BYK®—W 9011 available from Byk, copolymer comprising acidic functional groups, like BYK®—W 969 available from Byk and alkylol ammonium salt of an acidic polyester. Combinations of dispersing agents may be used.

The cobalt free prepromoted unsaturated polyester resin system can comprise a co-promoter to enhance cure. Co-promoters useful in the invention include 2,4-petendione (“2,4-PD”), 2-acetylbutyrolactone, ethyl acetoacetonate, n,n-diethyl acetoacetamide and the like, and combinations thereof.

The cobalt free prepromoted unsaturated polyester resin system may comprise a coupling agent. Coupling agents useful in the invention include but are not limited to silanes, e.g. 3-trimethoxy-silyl-propyl-methacrylate, and silane modified polyethylene glycol.

The cobalt free prepromoted unsaturated polyester resin system may also comprise rheology modifiers. Typical rheology modifiers include fumed silica, organic clay and combinations thereof.

In addition, the cobalt free prepromoted unsaturated polyester resin system may comprise other conventional additives such as synergist agents. These synergist agents include polysorbate 20 (Tween 20), polyhydroxycarboxylic acid esters, such as BYK®—R605 and R606 available from Byk and the like, and combinations thereof.

A preferred aspect of the invention relates to a specific element of the formable composition according to the invention, namely to a cobalt free prepromoted unsaturated polyester resin system comprising
(i) a unsaturated polyester resin component; preferably a reaction product of a mixture comprising at least 1, 2 or 3 diols selected from the group consisting of propylene glycol, dipropylene glycol, ethylene glycol, and diethylene glycol; and at least 1, 2, 3 or 4 acids selected from the group consisting of maleic acid, isopthalic acid, phthalic acid, and adipic acid, or their acid anhydrides;
(ii) a metal catalyst comprising zinc or copper and being capable of catalyzing curing of said unsaturated polyester resin component; preferably a zinc salt of a carboxylic acid, more preferably a zinc salt of a C₁₋₂₀ carboxylic acid, still more preferably a zinc salt of a C₆₋₁₂ carboxylic acid, most preferably zinc octanoate;
(iii) a benzyl-N,N,N-trialkylammonium salt and/or a N,N,N,N-tetraalkylammonium salt; preferably a benzyl-N,N,N—C₂₋₂₀-alkyl-dimethyl-ammonium salt, or a benzyl-N,N,N-trimethylammonium salt, or a N,N—C₂₋₂₀-dialkyl-N,N-dimethylammonium salt; and
(iv) optionally, one or more additives selected from the group consisting of reactive diluents, accelerators, co-promoters, dispersing agents, UV absorbers, stabilizers and rheology modifiers.

The content of the metal catalyst, preferably zinc octanoate, relative to the total weight of the cobalt free prepromoted unsaturated polyester resin system according to the invention, is preferably within the range of from about 0.001 wt.-% to about 1 wt.-%, more preferably about 0.01 wt.-% to about 0.1 wt.-%. Preferably, the content of the metal catalyst, preferably zinc octanoate, relative to the total weight of the cobalt free prepromoted unsaturated polyester resin system according to the invention, is within the range of about 0.20±0.15 wt.-%, more preferably about 0.20±0.10 wt.-%, most preferably about 0.20±0.05 wt.-%.

The content of the ammonium salt, preferably benzyl-N,N,N-trialkylammonium salt, preferably benzyl-N,N,N—C₂₋₂₀-alkyl-dimethyl-ammonium salt or a benzyl-N,N,N-trimethylammonium salt, relative to the total weight of the cobalt free prepromoted unsaturated polyester resin system according to the invention, is preferably within the range of from about 0.001 wt.-% to about 5 wt.-%, more preferably about 0.01 wt.-% to about 0.5 wt.-%. Preferably, the content of the benzyl-N,N,N-trialkylammonium salt, preferably benzyl-N,N,N—C₂₋₂₀-alkyl-dimethyl-ammonium salt or a benzyl-N,N,N-trimethylammonium salt, relative to the total weight of the cobalt free prepromoted unsaturated polyester resin system according to the invention, is within the range of about 0.20±0.15 wt.-%, more preferably about 0.20±0.10 wt.-%, most preferably about 0.20±0.05 wt.-%.

The formable composition according to the invention contains an inorganic particulate material. Typically, the inorganic particulate material is the main constituent of the formable composition and provides the engineered stone with the desired appearance.

Preferably, the inorganic particulate material is made from stone, e.g. crushed stone. Suitable stone sources include but are not limited to Preferably, the inorganic particulate material that is contained in the formable composition according to the invention comprises an aggregate, preferably quartz aggregate. Preferably, the aggregate is a fine aggregate and/or a coarse aggregate.

Preferably, a fine aggregate is a material that almost entirely passes through a Number 4 sieve (ASTM C 125 and ASTM C 33), such as silica sand. Preferably, a coarse aggregate is a material that is predominantly retained on a Number 4 sieve (ASTM C 125 and ASTM C 33), such as silica, quartz, crushed marble, glass spheres, granite, limestone, calcite, feldspar, alluvial sands, sands or any other durable aggregate, and mixtures thereof.

As such, the term “aggregate” is used broadly to refer to a number of different types of both coarse and fine particulate material, including, but are not limited to, sand, gravel, crushed stone, slag, and recycled concrete. The amount and nature of the aggregate may vary widely. In some embodiments, the amount of aggregate may range from about 10 wt.-% to about 90 wt.-%, relative to the total content of inorganic particulate material.

Preferably, the inorganic particulate material that is contained in the formable composition according to the invention comprises quartz fillers. In this regard, fillers are to be distinguished from aggregates due to their larger average particle size.

Preferably, the largest particle size is 1.2 mm, i.e. the inorganic particulate material preferably does not contain a significant amount of particles larger than 1.2 mm. Preferably, the average particle size of the inorganic particulate material is within the range of from 10 μm to 50 μm, 20 μm to 60 μm, 30 μm to 70 μm, 10 μm to 30 μm, 20 μm to 40 μm, 30 μm to 50 μm, 40 μm to 60 μm, or 50 μm to 70 μm.

Preferred embodiments concerning the particle size distribution of the inorganic particulate material are summarized as embodiments A¹ to A⁸ in the table below (all values in wt.-%):

| particle size | A¹ | A² | A³ | A⁴ | A⁵ | A⁶ | A⁷ | A⁸ |
|---|---|---|---|---|---|---|---|---|
| <0.1 μm | <5.0 | <4.0 | <3.0 | <2.5 | <2.0 | <1.5 | <1.0 | <0.5 |
| 0.1-0.3 μm | 15-95 | 20-90 | 25-85 | 30-80 | 35-75 | 40-70 | 45-65 | 50-60 |
| 0.3-0.6 μm | 1-35 | 3-32 | 5-30 | 7-28 | 9-26 | 11-24 | 13-22 | 15-20 |
| >0.6 μm | 4-51 | 7-48 | 10-45 | 13-42 | 16-39 | 19-36 | 22-33 | 25-30 |

Preferred embodiments concerning the particle size distribution of the inorganic particulate material are summarized as embodiments A⁹ to A¹⁶ in the table below (all values in wt.-%):

| particle size | A⁹ | A¹⁰ | A¹¹ | A¹² | A¹³ | A¹⁴ | A¹⁵ | A¹⁶ |
|---|---|---|---|---|---|---|---|---|
| <100 μm | 10-50 | 12-48 | 15-45 | 17-43 | 19-41 | 21-39 | 23-37 | 25-35 |
| 100-300 μm | 5-45 | 7-43 | 10-40 | 12-38 | 14-36 | 16-34 | 18-32 | 20-30 |
| 300-600 μm | 15-55 | 17-52 | 20-50 | 22-48 | 24-46 | 26-44 | 28-42 | 30-40 |

In a preferred embodiment, the inorganic particulate material has a particle size distribution such that
about 30 wt.-% to about 70 wt.-% of the particles have a particle size within the range of from about 0.1 μm to about 0.3 μm;
about 5 wt.-% to about 30 wt.-% of the particles have a particle size within the range of from about 0.3 μm to about 0.6 μm; and
about 10 wt.-% to about 40 wt.-% of the particles have a particle size within the range of from about 20 μm to about 60 μm.

Suitable methods for determining the average particle size and particle size distribution of an inorganic particulate material are known to the skilled person such as laser light scattering according to ASTM C1070-01(2014) or electric sensing zone technique according to ASTM C690-09.

Preferably, the content of the inorganic filler material is about 70 wt.-% to about 99.9 wt.-%, more preferably about 80 wt.-% to about 95 wt.-%, relative to the total weight of the formable composition. Preferably, the content of the inorganic filler material is within the range of about 90±7 wt.-%, more preferably about 90±6 wt.-%, still more preferably about 90±5 wt.-%, yet more preferably about 90±4 wt.-%, even more preferably about 90±3 wt.-%, most preferably about 90±2 wt.-%, and in particular about 90±1 wt.-%, relative to the total weight of the formable composition.

In order to induce curing of the formable composition according to the invention, a radical initiator is needed. The initiator generates free radicals reacting with the ethylenic unsaturations of the unsaturated polyester resin component, thereby causing cross-linking of the polymer network. Preferred peroxides are organic peroxides that work together with the metal catalyst (promoters) to initiate the chemical reaction that causes a resin to gel and harden. The amount of time from which the peroxide is added until the resin begins to gel is referred to as the “gel time” or “pot life”. Peroxide and metal catalyst levels can be adjusted, to a certain extent, to shorten or lengthen the gel time and accommodate both high and low temperatures. If a longer gel time is required, inhibitors can be added.

Preferably, the peroxide component is a hydroperoxide and/or an organic peroxide, more preferably an organic hydroperoxide.

Preferably, the peroxide component is selected from the group consisting of methyl ethyl ketone peroxide (MEKP), methyl isobutyl ketone peroxide (MIKP), benzoyl peroxide (BPO), tert-butyl peroxibenzoate (TBPB), cumene hydroperoxide (CHP), and mixtures thereof.

Cumene hydroperoxide and/or methyl isobutyl ketone peroxide are particularly preferred. It has been surprisingly found that cumene hydroperoxide and/or methyl isobutyl ketone peroxide as peroxide component, preferably in combination with zinc salts or copper salts as metal catalysts (promoters), has particular advantages with respect to pot life, appearance and mechanical properties of the engineered stone, allowing for the complete omission of cobalt salts.

Preferably, the content of the peroxide component, preferably cumene hydroperoxide and/or methyl isobutyl ketone peroxide, is about 0.01 wt.-% to about 5.0 wt.-%, more preferably about 0.05 wt.-% to about 4.0 wt.-%, relative to the total weight of the unsaturated polyester resin component. Preferably, the content of the peroxide component, preferably cumene hydroperoxide, relative to the total weight of the cobalt free prepromoted unsaturated polyester resin system according to the invention, is within the range of about 2.0±1.5 wt.-%, more preferably about 2.0±1.0 wt.-%, most preferably about 2.0±0.5 wt.-%.

Preferably, the content of the peroxide component, preferably cumene hydroperoxide and/or methyl isobutyl ketone peroxide, is about 0.001 wt.-% to about 0.1 wt.-%, more preferably about 0.005 wt.-% to about 0.05 wt.-%, relative to the total weight of the formable composition. Preferably, the content of the peroxide component, preferably cumene hydroperoxide and/or methyl isobutyl ketone peroxide, relative to the total weight of the formable composition according to the invention, is within the range of about 0.20±0.15 wt.-%, more preferably about 0.20±0.10 wt.-%, most preferably about 0.20±0.05 wt.-%.

Preferred embodiments concerning the nature of metal catalyst, ammonium salt and peroxide are summarized as embodiments B¹ to B²⁸ in the table below:

| | metal catalyst | ammonium salt | peroxide |
|---|---|---|---|
| B¹ | zinc salt of | benzyl-N,N,N-C₂₋₂₀-alkyl- | organic peroxide |
| | carboxylic acid | dimethyl-ammonium salts | |
| B² | zinc salt of | benzyl-N,N,N-trimethyl- | organic peroxide |
| | carboxylic acid | ammonium salts | |
| B³ | zinc salt of | benzyl-N,N,N-C₂₋₂₀-alkyl- | hydroperoxide |
| | C₁-₂₀ carboxylic acid | dimethyl-ammonium salts | |
| B⁴ | zinc salt of | benzyl-N,N,N-trimethyl- | hydroperoxide |
| | C₁-₂₀ carboxylic acid | ammonium salts | |
| B⁵ | zinc salt of | benzyl-N,N,N-C₂₋₂₀-alkyl- | organic hydroperoxide |
| | C₆-₁₂ carboxylic acid | dimethyl-ammonium salts | |
| B⁶ | zinc salt of | benzyl-N,N,N-trimethyl- | organic hydroperoxide |
| | C₆-₁₂ carboxylic acid | ammonium salts | |
| B⁷ | zinc octanoate | benzyl-N,N,N-C₂₋₂₀-alkyl- | cumene hydroperoxide |
| | | dimethyl-ammonium salts | |
| B⁸ | zinc octanoate | benzyl-N,N,N-trimethyl- | cumene hydroperoxide |
| | | ammonium salts | |
| B⁹ | zinc salt of | benzyl-N,N,N-C₂₋₂₀-alkyl- | methyl isobutyl ketone |
| | C₁-₂₀ carboxylic acid | dimethyl-ammonium salts | peroxide |
| B¹⁰ | zinc salt of | benzyl-N,N,N-trimethyl- | methyl isobutyl ketone |
| | C₁-₂₀ carboxylic acid | ammonium salts | peroxide |
| B¹¹ | zinc salt of | benzyl-N,N,N-C₂₋₂₀-alkyl- | methyl isobutyl ketone |
| | C₆-₁₂ carboxylic acid | dimethyl-ammonium salts | peroxide |
| B¹² | zinc salt of | benzyl-N,N,N-trimethyl- | methyl isobutyl ketone |
| | C₆-₁₂ carboxylic acid | ammonium salts | peroxide |
| B¹³ | zinc octanoate | benzyl-N,N,N-C₂₋₂₀-alkyl- | methyl isobutyl ketone |
| | | dimethyl-ammonium salts | peroxide |
| B¹⁴ | zinc octanoate | benzyl-N,N,N-trimethyl- | methyl isobutyl ketone |
| | | ammonium salts | peroxide |
| B¹⁵ | zinc salt of | N,N,N,N-tetraalkylammonium | organic peroxide |
| | carboxylic acid | salts | |
| B¹⁶ | zinc salt of | N,N-C₂₋₂₀- | organic peroxide |
| | carboxylic acid | dialkyldimethylammonium salts | |
| B¹⁷ | zinc salt of | N,N,N,N-tetraalkylammonium | hydroperoxide |
| | C₁-₂₀ carboxylic acid | salts | |
| B¹⁸ | zinc salt of | N,N-C₂₋₂₀- | hydroperoxide |
| | C₁-₂₀ carboxylic acid | dialkyldimethylammonium salts | |
| B¹⁹ | zinc salt of | N,N,N,N-tetraalkylammonium | organic hydroperoxide |
| | C₆-₁₂ carboxylic acid | salts | |
| B²⁰ | zinc salt of | N,N-C₂₋₂₀- | organic hydroperoxide |
| | C₆-₁₂ carboxylic acid | dialkyldimethylammonium salts | |
| B²¹ | zinc octanoate | N,N,N,N-tetraalkylammonium | cumene hydroperoxide |
| | | salts | |
| B²² | zinc octanoate | N,N-C₂₋₂₀- | cumene hydroperoxide |
| | | dialkyldimethylammonium salts | |
| B²³ | zinc salt of | N,N,N,N-tetraalkylammonium | methyl isobutyl ketone |
| | C₁-₂₀ carboxylic acid | salts | peroxide |
| B²⁴ | zinc salt of | N,N-C₂₋₂₀- | methyl isobutyl ketone |
| | C₁-₂₀ carboxylic acid | dialkyldimethylammonium salts | peroxide |
| B²⁵ | zinc salt of | N,N,N,N-tetraalkylammonium | methyl isobutyl ketone |
| | C₆-₁₂ carboxylic acid | salts | peroxide |
| B²⁶ | zinc salt of | N,N-C₂₋₂₀- | methyl isobutyl ketone |
| | C₆-₁₂ carboxylic acid | dialkyldimethylammonium salts | peroxide |
| B²⁷ | zinc octanoate | N,N,N,N-tetraalkylammonium | methyl isobutyl ketone |
| | | salts | peroxide |
| B²⁸ | zinc octanoate | N,N-C₂₋₂₀- | methyl isobutyl ketone |
| | | dialkyldimethylammonium salts | peroxide |

Preferably, the formable composition according to the invention has a pot life of at least about 30 minutes, more preferably at least about 1 hour, still more preferably at least about 1.5 hours and most preferably at least about 2 hours. Preferably, at 40° C. the pot life of the formable composition according to the invention, measured after mixing components (A) and (C) and optionally (B), is within the range of about 4.3±3.5 hours, more preferably about 4.3±3.0 hours, still more preferably about 4.3±2.5 hours, yet more preferably about 4.3±2.0 hours, even more preferably about 4.3±1.5 hours, most preferably about 4.3±1.0 hours, and in particular about 4.3±0.5 hours.

Preferably, the formable composition according to the invention has a polymerization time at 110° C. of at least about 30 minutes, more preferably at least about 1 hour. Preferably, at 110° C. the polymerization time of the formable composition according to the invention, is within the range of about 60±35 minutes, more preferably about 60±30 minutes, still more preferably about 60±25 minutes, yet more preferably about 60±20 minutes, even more preferably about 60±15 minutes, most preferably about 60±10 minutes, and in particular about 60±5 minutes.

Another aspect of the invention relates to a method for the preparation of engineered stone comprising the steps of

(a) preparing a formable composition by mixing
(A) a cobalt free prepromoted unsaturated polyester resin system as defined above;
(B) an inorganic particulate material as defined above; and
(C) a peroxide component as defined above;

(b) forming the composition prepared in step (a) into a desired shape; and

(c) allowing the composition formed in step (b) to cure.

All preferred embodiments of the formable composition according to the invention that have been defined above analogously also apply to the method according to the invention and thus, are not repeated hereinafter.

Another aspect of the invention relates to engineered stone that obtainable by the method according to the invention.

Preferably, the engineered stone according to the invention has a flexural strength of at least about 40 MPa, more preferably at least about 45 MPa, still more preferably at least about 50 MPa, and most preferably at least about 55 MPa. Preferably, the flexural strength is within the range of about 62±35 MPa, more preferably about 62±30 MPa, still more preferably about 62±25 MPa, yet more preferably about 62±20 MPa, even more preferably about 62±15 MPa, most preferably about 62±10 MPa, and in particular about 62±5 MPa. Methods for determining the flexural strength of engineered stone are known to the skilled person, e.g. ASTM C880.

Preferably, the engineered stone according to the invention has an impact resistance of at least about 2 J/m, more preferably at least about 2.5 J/m, still more preferably at least about 3 J/m, and most preferably at least about 3.5 J/m. Preferably, the impact resistance is within the range of about 4.5±3.5 J/m, more preferably about 4.5±3.0 J/m, still more preferably about 4.5±2.5 J/m, yet more preferably about 4.5±2.0 J/m, even more preferably about 4.5±1.5 J/m, most preferably about 4.5±1.0 J/m, and in particular about 4.5±0.5 J/m. Methods for determining the impact resistance of engineered stone are known to the skilled person, e.g. standard EN 41617-9.

Preferably, the engineered stone according to the invention has a linear stability of at most about 50·10⁻⁶ m/m° C., more preferably at most about 45·10⁻⁶ m/m° C., still more preferably at most about 40·10⁻⁶ m/m° C., and most preferably at most about 35·10⁻⁶ m/m ° C. Preferably, the linear stability is within the range of about 18±14·10⁻⁶ m/m° C., more preferably about 18±12·10⁻⁶ m/m° C., still more preferably about 18±10·10⁻⁶ m/m° C., yet more preferably about 18±8·10⁻⁶ m/m° C., even more preferably about 18±6·10⁻⁶ m/m° C., most preferably about 18±4·10⁻⁶ m/m° C., and in particular about 18±2·10⁻⁶ m/m° C. Methods for determining the linear stability of engineered stone are known to the skilled person, e.g. ASTM C179.

Another aspect of the invention relates to the use of the cobalt free prepromoted unsaturated polyester resin system according to the invention for the preparation of engineered stone, preferably in the method according to the invention.

The following examples further illustrate the invention but are not to be construed as limiting its scope.

### EXAMPLE 1

The following 6 resin compositions were prepared and their pot lifes as well as their curing properties were determined:

Engineered Stone Polyester Resin

| [wt.-%] | 1-1 | 1-2 | 1-3 | 1-4 | 1-5 | 1-6 |
|---|---|---|---|---|---|---|
| unsaturated polyester | UPR-1 | UPR-1 | UPR-1 | UPR-1 | UPR-1 | UPR-1 |
| resin component | | | | | | |
| processability at 40° C. | 95 min | 100 min | 360 min | >24 hours | 130 min | >24 hours |
| curing time at 80° C. | 9.2 min | 9.7 min | 11.5 min | >50 min | 9.7 min | 21.2 min |
| (25° C.-PEC) | | | | | | |
| PEC | 213.2° C. | 211.2° C. | 221.1° C. | — | 213.1° C. | 217.8° C. |
| metal catalyst^{1, 2} | 0.2% Co | 0.2% Zn (8%) + | 0.2% Zn | 0.2% Zn | 0.2% Zn | 0.2% Zn |
| | (6%) | 0.2% Co (6%) | (8%) | (8%) | (8%) | (8%) |
| ammonium salt | — | 0.2% | 0.2% | 0.2% | 0.2% | 0.2% |
| | | Empigen | Empigen | Empigen | Empigen | Empigen |
| peroxide component | 2% | 2% CHP | 2% CHP | 2% TBPB | 2% MIKP | 2% BPO |
| | TBPB | | | | | |

¹ percentages without parentheses indicate added amount of composition comprising metal catalyst, relative to the total weight of the resin
² percentages in parentheses indicate content of metal salt in composition comprising metal catalyst, relative to the total weight of the composition comprising metal catalyst
UPR-1 reaction product of a mixture comprising one or more diols selected from the group consisting of propylene glycol, dipropylene glycol, ethylene glycol, and diethylene glycol; and one or more acids selected from the group consisting of maleic acid, isophthalic acid, phthalic acid, and adipic acid, or their acid anhydrides
PEC exothermic peak temperature upon curing of unsaturated polyester resin
TBPB tert-butyl peroxibenzoate
CHP cumene hydroperoxide
MIKP methyl isobutyl ketone peroxide
BPO benzoyl peroxide
Empigen benzyl trialky ammonium salt

The resin composition according to example 1-1 (comparative) could be processed at 40° C. for only 95 minutes, whereas under identical conditions the resin composition according to example 1-3 (inventive) could be processed for 360 minutes. The resin composition according to example 1-5 (inventive) clearly had a better processability at 40° C. compared to the resin composition according to examples 1-1 and 1-2 (comparative), but not as good as that according to example 3 (inventive).

### EXAMPLE 2

Engineered stone was prepared from a resin composition containing 10 wt.-% resin (UPR-2). The resin was prepromoted with 0.2% Zn 8% and 0.2% of Empigen Bac80. UPR-2 was a reaction product of a mixture comprising one or more diols selected from the group consisting of propylene glycol, dipropylene glycol, ethylene glycol, and diethylene glycol; and one or more acids selected from the group consisting of maleic acid, isophthalic acid, phthalic acid, and adipic acid, or their acid anhydrides; the composition of UPR-2 differed from that of UPR-1 according to example 1.

Quartz particles having the following particle size distribution were employed:
Quartz 45 microns: 30%
Quartz 0.1-0.3 mm: 25%
Quartz 0.3-0.6 mm: 35%

The following additional components were added:

Silane: 2 wt.-% relative to the total weight of the resin;

TiO₂: 17 wt.-%% relative to the total weight of the resin;

CHP: 2 wt.-% relative to the total weight of the resin, as a peroxide.

Slabs of 3 cm thickness were produced and cured under conventional curing conditions (38 minutes at 115° C. inside an oven). After cooling down to room temperature and waiting for 24 hours at room temperature, the slabs were polished.

The flexural strength of the slabs was 64 MPa and their impact resistance was 7 J.

50 square meters of slabs were produced from 400 kg of resin during 4 hours of continuous operation. There was no need to shut down the production line for cleaning, i.e. the processability of the resin composition was >4 hours.

### EXAMPLE 3

A comparative engineered stone polyester resin comprising 0.19% Co (6%) and 1.79 TBPB could be processed at 40° C. for 1 hour 55 minutes.

Engineered stone polyester resin according to the invention not containing cobalt could be processed at the same conditions for 3.5 hours:

Engineered stone polyester resin

| | 3-1 | 3-2 | 3-3 | 3-4 |
|---|---|---|---|---|
| unsaturated polyester | UPR-3 | UPR-3 | UPR-3 | UPR-3 |
| resin component | | | | |
| PEC [° C.] | 214 | 203.7 | 213.5 | 221.4 |
| curing time at 80° C. | 8.3 | 8.6 | 8.9 | 12 |
| [min] | | | | |
| processability at 40° C. | 68 | 12.5 | 89 | 110 |
| [min] | | | | |
| metal catalyst | 0.2 ml Co | 0.2% Co | 0.2% Zn | 0.2% Zn |
| (per 100 g)^{1,2} | (6%) | (6%) | | |
| ammonium salt | — | — | 0.2% | 0.2% |
| (per 100 g) | | | Empigen | Empigen |
| peroxide component | 2 ml | 2% MIKP | 2% MIKP | 2% CHP |
| (per 100 g) | TRIG 93 | | | |

¹percentages without parentheses indicate added amount of composition comprising metal catalyst, relative to the total weight of the resin
²percentages in parentheses indicate content of metal salt in composition comprising metal catalyst, relative to the total weight of the composition comprising metal catalyst
UPR-3 reaction product of a mixture comprising one or more diols selected from the group consisting of propylene glycol, dipropylene glycol, ethylene glycol, and diethylene glycol; and one or more acids selected from the group consisting of maleic acid, isophthalic acid, phthalic acid, and adipic acid, or their acid anhydrides; the composition of UPR-3 differed from that of UPR-1 and UPR-2 according to examples 1 and 2
PEC exothermic peak temperature upon curing of unsaturated polyester resin
TRIG 93 commercial product comprising tert-butyl peroxibenzoate (TBPB)
CHP cumene hydroperoxide
MIKP methyl isobutyl ketone peroxide
Empigen benzyl trialky ammonium salt

The above experimental data demonstrate that the cobalt free compositions according to the invention have unexpected advantages compared to the compositions of the prior art, e.g. compared to the cobalt containing compositions according to EP-A 2 610 227.

1. A formable composition for the preparation of engineered stone comprising
(A) a cobalt free prepromoted unsaturated polyester resin system comprising
(i) a unsaturated polyester resin component;
(ii) a metal catalyst capable of catalyzing curing of said unsaturated polyester resin component;
(iii) a quaternary ammonium salt; and
(iv) optionally, one or more additives selected from the group consisting of reactive diluents, accelerators, co-promoters, dispersing agents, UV absorbers, stabilizers, inhibitors and rheology modifiers;
(B) an inorganic particulate material; and
(C) a peroxide component.

2. The composition according to claim 1, wherein the metal catalyst comprises zinc or copper.

3. The composition according to claim 1 or 2, wherein the quaternary ammonium salt is a benzyl-N,N,N-trialkylammonium salt or a N,N,N,N-tetraalkylammonium salt.

4. The composition according to any of the preceding claims, wherein the unsaturated polyester resin component is obtained by reacting a mixture comprising a multicarboxylic acid component and a polyhydric alcohol component, wherein the multicarboxylic acid component and/or the polyhydric alcohol component comprises ethylenic unsaturation;
wherein preferably the multicarboxylic acid component is selected from the group consisting of aliphatic dicarboxylic acids, aliphatic tricarboxylic acids, aliphatic tetracarboxylic acids, aromatic dicarboxylaic acids, aromatic tricarboxylic acids and aromatic tetracarboxylic acids; and/or
wherein preferably the polyhydric alcohol is selected from the group consisting of aliphatic diols, aliphatic triols, aliphatic tetraols, aromatic diols, aromatic triols and aromatic tetraols.

5. The composition according to any of the preceding claims, wherein the unsaturated polyester resin component is a reaction product of a mixture comprising at least 1, 2 or 3 diols selected from the group consisting of propylene glycol, dipropylene glycol, ethylene glycol, and diethylene glycol; and at least 1, 2, 3 or 4 acids selected from the group consisting of maleic acid, isophthalic acid, phthalic acid, and adipic acid, or their acid anhydrides.

6. The composition according to any of the preceding claims, wherein the cobalt free prepromoted unsaturated polyester resin system comprises a reactive diluent selected from the group consisting of styrene, substituted styrene, nono-, di- and polyfunctional esters of monofunctional acids with alcohols or polyols, mono-, di- and polyfunctional esters of unsaturated monofunctional alcohols with carboxylic acids or their derivatives.

7. The composition according to any of the preceding claims, wherein the inorganic particulate material comprises quartz aggregates and/or quartz fillers.

8. The composition according to any of the preceding claims, wherein the inorganic particulate material has a particle size distribution such that
about 30 wt.-% to about 70 wt.-% of the particles have a particle size within the range of from about 0.1 μm to about 0.3 μm;
about 5 wt.-% to about 30 wt.-% of the particles have a particle size within the range of from about 0.3 μm to about 0.6 μm; and
about 10 wt.-% to about 40 wt.-% of the particles have a particle size within the range of from about 20 μm to about 60 μm.

9. The composition according to any of the preceding claims, wherein the peroxide component is cumene hydroperoxide or methyl isobutyl ketone peroxide.

10. The composition according to any of the preceding claims, which has a pot life of at least about 30 minutes.

11. The composition according to any of the preceding claims, wherein the content of the cobalt free prepromoted unsaturated polyester resin system is about 0.1 wt.-% to about 30 wt.-%, relative to the total weight of the formable composition; and/or wherein the content of the inorganic filler material is about 70 wt.-% to about 99.9 wt.-%, relative to the total weight of the formable composition.

12. A method for the preparation of engineered stone comprising the steps of
(a) preparing a formable composition by mixing
(A) a cobalt free prepromoted unsaturated polyester resin system as defined in any of claims 1 to 6;
(B) an inorganic particulate material as defined in any of claim 1, 7 or 8; and
(C) a peroxide component as defined in any of claim 1 or 9;
(b) forming the composition prepared in step (a) into a desired shape; and
(c) allowing the composition formed in step (b) to cure.

13. Engineered stone obtainable by the method according to claim 12.

14. A cobalt free prepromoted unsaturated polyester resin system comprising
(i) a unsaturated polyester resin component;
(ii) a metal catalyst comprising zinc or copper and being capable of catalyzing curing of said unsaturated polyester resin component;
(iii) a benzyl-N,N,N-trialkylammonium salt or a N,N,N,N-tetraalkylammonium salt; and
(iv) optionally, one or more additives selected from the group consisting of reactive diluents, accelerators, co-promoters, dispersing agents, UV absorbers, stabilizers and rheology modifiers.

15. Use of a cobalt free prepromoted unsaturated polyester resin system as defined in any of claim 1 to 6 or 14 for the preparation of engineered stone.
